(19) United States
(12) Patent Application Publication
(10) Pub. No.: US 2018/0025389 A1
(43) Pub. Date: Jan. 25, 2018

(54) DETERMINING AN EFFICIENT BID AMOUNT FOR EACH IMPRESSION OPPORTUNITY FOR A CONTENT ITEM TO BE PRESENTED TO A VIEWING USER OF AN ONLINE SYSTEM

(71) Applicant: Facebook, Inc., Menlo Park, CA (US)

(72) Inventors: Ramnik Arora, Palo Alto, CA (US); Kurt Dodge Runke, Los Altos, CA (US)

(21) Appl. No.: 15/216,529

(22) Filed: Jul. 21, 2016

(51) Int. Cl. G06Q 30/02; H04L 29/08

(52) U.S. Cl. CPC G06Q 30/0275; H04L 67/306; G06Q 30/0244

(57) ABSTRACT

An online system determines an advertiser value curve specific to a content item that may be presented to a viewing user of the online system, where points along the advertiser value curve represent values of potential impressions that may be obtained for the content item, which decreases as the number of potential impressions increases. The online system also determines a user cost curve specific to the viewing user, where points along the user cost curve represent costs of previous impressions of one or more content items obtained for the viewing user, which increases as the number of impressions of the content items increases. An efficient bid amount for each impression opportunity for the viewing user to view the content item is determined based on a number of total impressions and a bid amount that are associated with an intersection of the curves.

### BACKGROUND

This disclosure relates generally to online systems, and more specifically to determining an efficient bid amount associated with a content item that is used to select content for presentation to users of an online system.

An online system allows its users to connect and communicate with other online system users. Users create profiles on the online system that are tied to their identities and include information about the users, such as interests and demographic information. The users may be individuals or entities such as corporations or charities. Because of the popularity of online systems and the significant amount of user-specific information maintained by online systems, an online system provides an ideal forum for allowing users to share content by creating content items for presentation to additional online system users. For example, users may share photos or videos they have uploaded by creating content items that include the photos or videos that are presented to additional users to which they are connected on the online system. An online system also provides advertisers with abundant opportunities to increase awareness about their products or services by presenting advertisements to online system users. For example, advertisements presented to users allow an advertiser to gain public attention for products or services and to persuade online system users to take an action regarding the advertiser's products, services, opinions, or causes.

Conventionally, online systems generate revenue by displaying content to their users. For example, an online system may charge advertisers for each presentation of an advertisement to an online system user (i.e., each “impression”), or for each interaction with an advertisement by an online system user. Furthermore, by presenting content that encourages user engagement with online systems, online systems may increase the number of opportunities they have to generate revenue. For example, if a user scrolls through a newsfeed to view content that captures the user's interest, advertisements that are interspersed in the newsfeed also may be presented to the user.

Online systems usually select content items for presentation to online system users based on values associated with the content items that are used in a content selection process (e.g., an advertisement auction). For example, each content item that is eligible for presentation to a user of an online system is associated with a value (e.g., a score or a bid amount) and a content selection process ranks the content items based on their associated values and selects a threshold number of highest ranked content items for presentation to the user. The value associated with a content item may be provided by a user associated with the content item that indicates the price of a potential impression that may be obtained for the content item. For example, if the content item is an advertisement, the value associated with the content item is a bid amount provided by an advertiser that specifies a price the advertiser is willing to pay in exchange for an impression achieved for the content item.

However, when users provide values to be used in a content selection process, they often do not account for fluctuations in the value required to achieve an impression of a content item (i.e., the cost of the impression). For example, values associated with achieved impressions frequently fluctuate among different online system users and even for a given user. By failing to account for such fluctuations, the values associated with content items that are used in a content selection process may be unnecessarily high when impressions are achieved for the content items, especially in situations where the presentation of the content items is not time-sensitive. For example, although an advertisement encouraging users to install a game application is able to obtain an impression for a user of an online system at a bid amount of $5.00, based on the user's historical impressions of content items, the impression likely would have been achieved within a few days at a bid amount of $3.50. Thus, conventional online systems may allow advertisers to overbid, and thus overpay, for impressions, which may cause them to search elsewhere for more inexpensive advertising options.

### SUMMARY

An online system determines an efficient bid amount for each opportunity for a particular viewing user of the online system to view a content item (i.e., each impression opportunity) based on a prediction of a number of total impressions that may be obtained for the viewing user for a given bid amount. To determine the efficient bid amount, the online system first determines an advertiser value curve specific to the content item (e.g., an advertisement) that may be presented to the viewing user. Values corresponding to points along the advertiser value curve represent values of different numbers of potential impressions that may be obtained for the content item, where a user associated with the content item (e.g., an advertiser) may provide the values (e.g., bid amounts the advertiser is willing to pay for each impression).

In various embodiments, the advertiser value curve may be determined based on different types of values. In one embodiment, the values may correspond to different numbers of potential interactions with the content item by the viewing user (e.g., values of different numbers of clicks on the content item, values of different numbers of times the viewing user may express a preference for the content item, etc.). The values also may describe scores or any other suitable values associated with the content item determined by the online system (e.g., scores based on predicted levels of interest of the viewing user in the content item for each impression of the content item). In some embodiments, the advertiser value curve is determined for the content item based on different locations in a display area or different positions within a content display unit in which the content item may be presented. For example, each point in the advertiser value curve may correspond to a value of each impression of the content item that potentially may be obtained for the viewing user, where the content item is presented in a particular position within a newsfeed or an equivalent position in a different display area of a client device.

In embodiments in which the values of the potential impressions are plotted as a function of the number of potential impressions that may be obtained for the content item, the values for the advertiser value curve decrease as the number of potential impressions increases. The reason for this is that the likelihood that users of the online system will perform actions associated with the content item (e.g., purchase products, join a group, etc.) decreases with each additional impression of the same content item, thus decreasing the value of each additional impression as well. For example, points along the advertiser value curve may describe bid amounts that are proportional to predicted likelihoods of interaction with the content item by the viewing user, which decrease with each additional impression of the content item. Similarly, if an advertiser value curve is determined based on scores or other types of values, the values for the curve also may decrease as the number of impressions increase. For example, if values for the advertiser value curve correspond to scores that are proportional to predicted levels of interest of the viewing user in the content item for each impression of the content item, since users are generally more interested in viewing new content than they are in viewing content that previously was presented to them, the scores decrease as the number of impressions increase.

The advertiser value curve may be determined for one or more viewing users of the online system. In one embodiment, the advertiser value curve is a generic curve that is determined for all viewing users of the online system (e.g., based on an average bid amount that potentially may be obtained for each impression of the content item by all viewing users). Alternatively, the advertiser value curve may be specific to a viewing user according to one embodiment. For example, if the viewing user has performed several actions associated with advertisements for a campaign in the past (e.g., purchased products or services associated with advertisements for the campaign after clicking on the advertisements), the bid amount associated with each impression in the advertiser value curve for a new advertisement for the campaign would be higher for the viewing user than for other users who previously have not performed actions associated with any advertisements for the campaign.

The advertiser value curve may be specific to a group of viewing users based on attributes associated with the users (e.g., users of a particular demographic group) and a predicted likelihood of relevance of the content item to viewing users having the associated attributes, according to one embodiment. For example, an advertiser value curve for a content item associated with entering a beauty pageant in California may be specific to female online system users between the ages of 18 and 25 who live in California. Alternatively, or in addition to the user-specific value curve bases, the advertiser value curve may be specific to a set of content items, such as a set of advertisements for an advertising campaign or a set of content items including similar types of content (e.g., videos or pictures).

To determine the efficient bid amount for each impression opportunity for the content item, the online system determines a user cost curve specific to the viewing user. The online system may determine the user cost curve based on historical impressions obtained for a viewing user, such that points along the user cost curve correspond to costs of impressions achieved for one or more content items previously presented to the viewing user. The cost of each impression may correspond to a cost incurred by one or more users associated with the content items (e.g., bid amounts paid by advertisers). For example, a point along the user cost curve corresponds to a number of impressions of a content item achieved for the viewing user (e.g., a first impression, a second impression, etc.) and a winning bid amount for the impression. In embodiments in which the user cost curve is based on historical impressions achieved for multiple content items, the cost corresponding to each number of impressions may be an average winning bid amount for the number of impressions or a winning bid amount for at least a threshold percentage of the number of impressions. The user cost curve may be determined based on information received from multiple content publishers. For example, the online system tracks impressions obtained for viewing users of multiple content publishers using a tracking mechanism (e.g., cookies) and determines the user cost curve for a particular viewing user based on impressions obtained for the user across all of the content publishers.

In embodiments in which the cost is plotted as a function of the number of impressions previously obtained for the viewing user, the costs for the user cost curve increase as the number of impressions of the same content item(s) increases for the same reason noted above. Namely, that viewing users of the online system are usually more interested in viewing content items that have never been presented to them than they are in viewing content items that previously were presented to them. Therefore, to maximize user engagement with the online system, the online system generally requires higher costs to be paid in exchange for presentation of content items that previously have been presented to a viewing user than for presentation of content items that previously have not been presented to the viewing user. For example, to increase the likelihood that an advertisement that is new to the viewing user is selected for presentation to the viewing user over advertisements that previously have been presented to the viewing user, the online system may multiply a bid amount associated with each advertisement by a factor that is inversely proportional to the number of previous impressions achieved by the advertisement, such that previously presented advertisements must generally be associated with a higher bid amount in order to be selected over the new advertisement in an advertisement auction held for each impression opportunity.

Just as the advertiser value curve may be determined based on scores or other suitable types of values associated with potential impressions, the user cost curve also may be determined based on similar types of costs associated with previous impressions. For example, points along the user cost curve may correspond to scores associated with previous impressions obtained for a content item, where the scores are based on levels of interest of the viewing user in the content item predicted by the online system and increase as the number of previous impressions of the content item increases. Also similar to the advertiser value curve, in some embodiments, the user cost curve accounts for particular locations in a display area or positions within a content display unit in which the content items were presented to the viewing user. For example, each point in the user cost curve corresponds to a bid amount paid by an advertiser for each of multiple impressions that were obtained for the viewing user for the same content item presented in a particular position within a feed of content items or an equivalent position in a different display area of a client device. Additionally, the costs for the user cost curve may represent costs of different numbers of previous interactions with content items by the viewing user (e.g., costs of different numbers of times the viewing user clicked on the content items, costs of different numbers of times the viewing user shared the content items with additional users of the online system, etc.).

The online system may update the user cost curve periodically or based on the viewing user's interactions with the online system. For example, if the online system predicts that there are 700 advertisement impression opportunities per week for a viewing user that normally logs into the online system at least once per day, but halfway through the week, the viewing user has not logged into the online system at all that week, the online system may adjust the user cost curve to compensate for the decreased number of advertisement impression opportunities for the user, such that the costs associated with the points along the user cost curve are increased. By the same reasoning, if the viewing user's frequency of interaction with the online system increases above a threshold frequency, the online system may adjust the user cost curve by decreasing costs associated with advertisement impressions in the user cost curve (e.g., by shifting the user cost curve to the left).

Once the advertiser value curve and the user cost curve have been determined, the online system determines the efficient bid amount for each impression opportunity for the content item being presented to the viewing user based on a value/cost associated with the intersection of the curves and a total number of impressions associated with the intersection. For example, if the intersection of the advertiser value curve and the user cost curve correspond to a bid amount of $5.75 and seven impressions, the online system predicts that a total of seven impressions may be obtained for a bid amount of $5.75 and therefore determines the efficient bid amount for each impression opportunity for the content item to be $5.75. The efficient bid amount for each impression opportunity may be approximated based on the intersection of the curves. For example, if the curves intersect at a point corresponding to a total of five impressions, the online system determines the efficient bid amount for each impression opportunity for a total of five impressions to be a bid amount corresponding to a point along the user cost curve that is less than, but within a threshold of the bid amount corresponding to the intersection of the curves. In embodiments in which the values for the advertiser value curve and the costs for the user cost curve are expressed as scores or other types of values/costs, an efficient score or other type of value may be similarly determined based on the intersection of the curves. For example, if the values for the advertiser value curve and the costs for the user cost curve are scores associated with different numbers of interactions with content items by the viewing user, an efficient score is determined for a total number of interactions corresponding to the intersection of the curves.

A content selection process (e.g., an auction system) may rank the content item among one or more additional content items based on the efficient bid amount determined for the content item and bid amounts associated with the additional content items and select content items associated with at least a threshold rank or bid amount for presentation to the viewing user. For example, if the online system receives a request to present content to the viewing user, the online system ranks content items eligible for presentation to the viewing user based on the efficient bid amount or any other suitable value associated with each content item, and selects one or more content items associated with at least a threshold bid amount for presentation to the viewing user. Similarly, in embodiments in which an efficient score or other type of value is determined for the content item, the content selection process may rank the content item among additional content items based on the corresponding scores/values.

The bid amount associated with the content item that is used in the content selection process may vary in different embodiments. In some embodiments, if multiple bid amounts are associated with the content item, a minimum bid amount is selected and included in the content selection process. For example, if the content item is an advertisement, values associated with the content item may include a bid amount provided by an advertiser and an efficient bid amount determined by the online system; the minimum bid amount for this advertisement is included in an auction used to select an advertisement for presentation to the viewing user. In additional embodiments, the efficient bid amount may be used in the content selection process if the number of total impressions associated with the efficient bid amount is less than a threshold number of impressions. For example, the online system determines a threshold number of impressions of the content item based on a frequency cap associated with presenting the content item; if the total number of impressions associated with the efficient bid amount is less than the threshold number of impressions, the efficient bid amount is used in the content selection process. Furthermore, if the efficient bid amount is approximated based on the intersection of the user cost curve and the advertiser value curve and fails to achieve at least a threshold number of impressions after a specified amount of time or after a specified number of impression opportunities, the online system may gradually increase the efficient bid amount for each impression opportunity until an impression is achieved or until the bid amount associated with the intersection of the curves is reached.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for determining an efficient bid amount for an impression opportunity for a content item presented to a viewing user of an online system, in accordance with an embodiment.

FIG. 4 is a conceptual diagram of a method for determining an efficient bid amount for an impression opportunity for a content item presented to a viewing user of an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

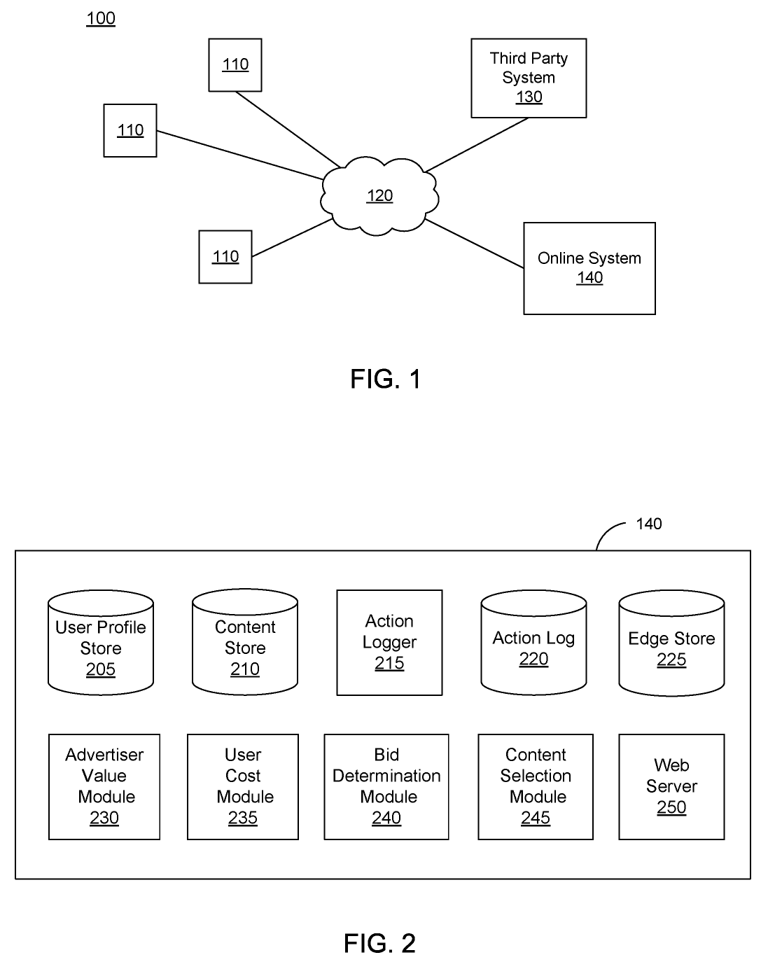

FIG. 1 is a block diagram of a system environment 100 for an online system 140. The system environment 100 shown by FIG. 1 comprises one or more client devices 110, a network 120, one or more third party systems 130, and the online system 140. In alternative configurations, different and/or additional components may be included in the system environment 100. The embodiments described herein may be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 also may communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an advertiser value module 230, a user cost module 235, a bid determination module 240, a content selection module 245, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

While user profiles in the user profile store 205 are frequently associated with individuals, allowing individuals to interact with each other via the online system 140, user profiles also may be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on the third party system 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 also may store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the social networking system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The advertiser value module 230 determines an advertiser value curve specific to a content item (e.g., an advertisement) that may be presented to a viewing user of the online system 140, where values corresponding to points along the advertiser value curve represent values of potential impressions of the content item that may be obtained for the viewing user. The advertiser value curve may be determined for the content item based on information received from a user associated with the content item. For example, if the content item is an advertisement, the advertiser value curve may be determined based on information received from an advertiser, such that the values correspond to bid amounts the advertiser is willing to pay in exchange for each impression that potentially may be obtained for the viewing user.

In embodiments in which the values of the potential impressions are plotted as a function of the number of potential impressions that may be obtained for the content item, the advertiser value curve is a decreasing curve. The reason the advertiser value curve decreases is that the likelihood that users of the online system 140 will be interested in and/or perform actions associated with the content item (e.g., purchase products, join a group, etc.) decreases with each additional impression of the content item, thus decreasing the value of each additional impression as well. For example, points along the advertiser value curve may describe bid amounts that are based on predicted levels of interest of the viewing user in the content item or predicted likelihoods of interaction with the content item by the viewing user, which decrease with each additional impression of the content item.

The advertiser value curve may be specific to multiple content items, such as advertisements for an advertising campaign or content items that are otherwise related in some manner. For example, the advertiser value curve is determined for advertisements for a new line of tablet devices, where each advertisement features the tablet in a different color, with a different memory capacity, and/or with a different screen size. As an additional example, the advertiser value curve is specific to a set of content items including similar types of content (e.g., videos or pictures). Additionally or alternatively, the advertiser value curve may be specific to one or more types of potential interactions with the content item by the viewing user. For example, the values for the advertiser value curve may represent values of different numbers of times the viewing user potentially may click on the content item or express a preference for the content item.

The advertiser value curve also may be specific to one or more viewing users of the online system 140. In one embodiment, the advertiser value curve is a generic curve that is determined for all viewing users of the online system 140. For example, the advertiser value curve is determined based on an average bid amount that potentially may be obtained for each impression of the content item by all viewing users as the number of impressions increase. Alternatively, the advertiser value curve may be specific to each viewing user. For example, if a viewing user previously has expressed a preference for and shared several content items tagged with the keyword “Hawaii,” the value associated with each impression in the advertiser value curve for an advertisement for Hawaiian vacation packages is higher for the viewing user than for other users who have not performed similar actions associated with content items related to Hawaii. The advertiser value curve also may be specific to a group of viewing users based on attributes associated with the users and a predicted likelihood of the relevance of the content item to viewing users having the associated attributes. For example, an advertiser value curve for a content item associated with wine tasting may be specific to online system users who are at least 21 years old.

The advertiser value module 230 may determine the advertiser value curve for the content item based on different locations in a display area or different positions within a content display unit in which the content item may be presented. In some embodiments, a different advertiser value curve is determined for each of the locations/positions and its equivalents. For example, each point in an advertiser value curve may represent the value of each impression of an advertisement that potentially may be obtained for the viewing user, where the advertisement is presented in a particular position within a feed (e.g., a top position in a newsfeed) or an equivalent position in a different location of a display area (e.g., in a banner).

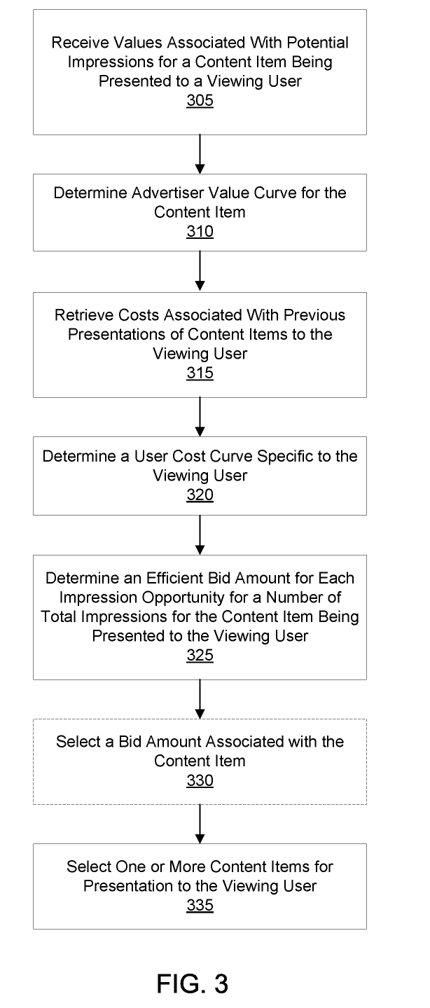

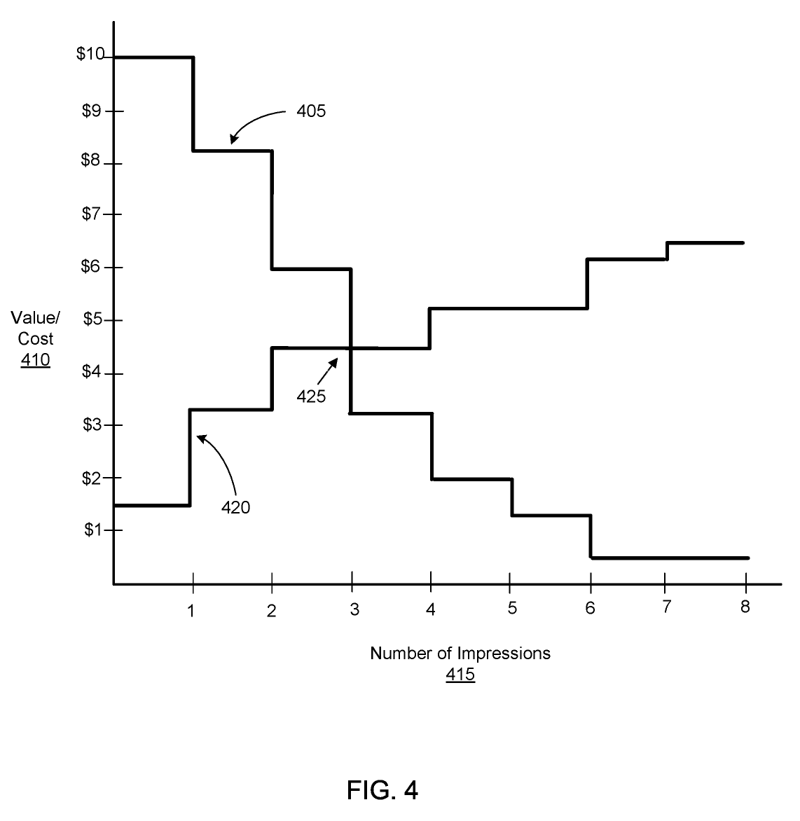

In some embodiments, the advertiser value curve is determined for a non-advertisement content item. For example, the advertiser value module 230 determines the advertiser value curve for a content item describing a check-in to a location by a user of the online system 140 connected to the viewing user by plotting points corresponding to a number of potential impressions of the content item and scores determined for each potential impression that describe the viewing user's predicted level of interest in the content item. In this example, since the user's predicted level of interest in the content item is likely to decrease as the number of impressions of the content item increase, the scores decrease for each additional potential impression of the content item. The functioning of the advertiser value module 230 is further described below in conjunction with FIGS. 3 and 4.

The user cost module 235 determines a user cost curve specific to a viewing user of the online system 140. The user cost module 235 may determine the user cost curve based on historical impressions achieved for the viewing user, such that each point along the user cost curve corresponds to a cost of an impression of one or more content items that previously was achieved for the viewing user. In various embodiments, the costs for the user cost curve may represent costs incurred by a user associated with the content item(s). For example, a point along the user cost curve corresponds to a number of impressions of a content item previously achieved for the viewing user and a minimum bid amount required to win an auction held for the impression opportunity that was paid by an advertiser.

In various embodiments, the costs for the user cost curve may be determined based on different types of information. In one embodiment, the cost associated with each impression in the user cost curve may be based on multiple costs associated with impressions obtained for the viewing user for multiple content items. For example, the user cost module 235 determines a bid amount associated with each number of impressions (e.g., first, second, etc.) of multiple content items, where the bid amount is a winning bid amount for at least a threshold percentage of the number of impressions. As an additional example, the user cost module 235 determines an average cost to advertisers for each number of impressions of multiple content items. In another embodiment, the user cost curve is determined based on information received from multiple content publishers. For example, the online system 140 tracks impressions obtained for viewing users of multiple content publishers using a tracking mechanism (e.g., cookies). In this example, the user cost module 235 may determine the user cost curve for a particular viewing user based on impressions obtained for the user across all of the content publishers. In yet another embodiment, the costs for the user cost curve represent costs of different numbers of previous interactions with content items by the viewing user (e.g., costs of different numbers of times the viewing user clicked on the content items, costs of different numbers of times the viewing user shared the content items with additional users of the online system 140, etc.).

In some embodiments, the user cost module 235 takes into account different locations in a display area of a client device 110 associated with the viewing user or different positions within a content display unit in which the content items were presented when the impressions were obtained for the viewing user. In one embodiment, to account for the positions in the display area in which the content items were presented at the time the impressions were achieved, a different user cost curve may be generated for each position equivalent in which the impressions were achieved for the same content item. For example, each point in a user cost curve represents an average bid amount paid by advertisers for impressions that were achieved for the viewing user for content items presented in a first position in a vertically scrollable newsfeed or an equivalent position in a different location of a display area of a client device 110 associated with the viewing user (e.g., in a first position in a horizontally scrollable advertisement unit, in a banner, in a pop-up window, etc.).

In embodiments in which the cost is plotted as a function of the number of impressions previously obtained for the viewing user, the costs for the user cost curve increase as the number of impressions of the same content item(s) increases in order to maximize user engagement with the online system 140. For example, the online system 140 may determine a score associated with each of several advertisements eligible to be presented to the viewing user, in which the score takes into account a bid amount associated with an advertisement and a number of impressions of the advertisement achieved for the viewing user; the advertisement associated with the highest score is then selected for presentation to the viewing user. In this example, since the selection of newer advertisements is favored over the selection of previously presented advertisements for presentation to the viewing user, the number of impressions may be weighted by a negative factor and the bid amount may be weighted by a positive factor when computing the score, such that advertisements must be associated with increasingly higher bid amounts to achieve each additional impression. As an additional example, the online system 140 may multiply a bid amount associated with an advertisement by a factor that is inversely proportional to the number of previous impressions achieved by the advertisement.

In some embodiments, the user cost curve is determined for non-advertisement content items. For example, the user cost module 235 determines a user cost curve for content items describing content posted by users of the online system 140 connected to the viewing user. If the user cost curve is determined for non-advertisement content items, the user cost curve for the content items may describe scores or any other suitable values describing costs associated with previous impressions of the content items. For example, the online system 140 determines scores associated with previous impressions of each of multiple content items based on the viewing user's predicted affinity for the content items; the user cost curve is then determined based on the scores, where the scores increase as the number of previous impressions increase.

The user cost module 235 may update the user cost curve periodically or based on the viewing user's interactions with the online system 140. For example, if the online system 140 predicts that there are 400 advertisement impression opportunities per week for a viewing user that normally logs into the online system 140 for an average of 30 minutes per day, but halfway through the week, the viewing user only has logged into the online system 140 an average of 10 minutes per day, the user cost module 235 may adjust the user cost curve to compensate for the decreased number of advertisement impression opportunities for the user, such that the bid amounts associated with the points along the user cost curve are increased. As an additional example, if the frequency of the viewing user's interactions with the online system 140 increases above a threshold frequency, the user cost module 235 may adjust the user cost curve by decreasing bid amounts associated with impressions in the user cost curve (e.g., by shifting the user cost curve to the left). The functionality of the user cost module 235 is further described below in conjunction with FIGS. 3 and 4.

The bid determination module 240 determines an efficient bid amount for each impression opportunity for the content item being presented to the viewing user. The efficient bid amount is determined based on a bid amount and a number of impressions associated with the intersection of the advertiser value curve and the user cost curve. For example, if the intersection of the advertiser value curve and the user cost curve corresponds to a bid amount of $7.25 and 13 impressions, the bid determination module 240 predicts that a total of 13 impressions may be obtained for a bid amount of $7.25 and therefore determines the efficient bid amount for each impression opportunity for the content item to be $7.25. In embodiments in which the values for the advertiser value curve and the costs for the user cost curve are associated with potential and previous interactions by the viewing user, respectively, the efficient bid amount is determined for each interaction opportunity for the viewing user based on a bid amount and a number of interactions associated with the intersection of the advertiser value curve and the user cost curve.

In some embodiments, the bid determination module 240 approximates the efficient bid amount for each impression opportunity based on the intersection of the curves. For example, if the curves intersect at a point corresponding to a total of six impressions, the bid determination module 240 determines the efficient bid amount for each impression opportunity for a total of six impressions to be a bid amount corresponding to a point along the user cost curve that is less than, but within a threshold of, the bid amount corresponding to the intersection of the curves. In embodiments in which the efficient bid amount for each impression opportunity is approximated based on the intersection of the user cost curve and the advertiser value curve, if the efficient bid amount fails to achieve at least a threshold number of impressions after a specified amount of time has elapsed or after a specified number of impression opportunities have come to pass, the bid determination module 240 may gradually increase the efficient bid amount for each impression opportunity until an impression is achieved or until the bid amount associated with the intersection of the curves is reached.

In embodiments in which the values for the advertiser value curve and the costs for the user cost curve are expressed as scores or other types of values/costs, an efficient score or other type of value may be determined based on the intersection of the curves. For example, the bid determination module 240 may determine an efficient score for each impression opportunity for a non-advertisement content item corresponding to an intersection of the advertiser value curve and the user cost curve. The bid determination module 240 may convert scores or values to bid amounts or vice versa so that the types of values corresponding to the number of impressions for the advertiser value curve and the types of costs corresponding to the user cost curve match and an efficient bid amount, score, or other suitable value may be determined by the bid determination module 240. For example, the bid determination module 240 may multiply scores associated with potential impressions that may be obtained for the content item along the advertiser value curve by a conversion factor that converts the scores into bid amounts.

In some embodiments, the efficient bid amount may be used in a content selection process that selects one or more content items for presentation to the viewing user if the bid determination module 240 determines that the number of total impressions corresponding to the efficient bid amount for the content item is less than a threshold number of impressions. The bid determination module 240 may determine the threshold number of total impressions based on various types of information. For example, the bid determination module 240 determines a threshold number of impressions of the content item based on a frequency cap associated with presenting the content item; if the total number of impressions corresponding to the efficient bid amount is less than the threshold number of impressions, the efficient bid amount is used in a content selection process (e.g., an auction system). As an additional example, if the goal of presenting a content item is for the viewing user to perform an action associated with the content item and a machine-learned model used in a content selection process will only decrease the frequency with which it presents the content item to the viewing user if the user fails to perform the action after a specified number of impressions, the bid determination module 240 determines that the threshold number of total impressions of the content item is equivalent to this specified number of impressions.

In some embodiments, if multiple bid amounts are associated with a content item, the bid determination module 240 selects a minimum bid amount from the multiple bid amounts for use in a content selection process used to select content items for presentation to the viewing user. For example, if bid amounts associated with an advertisement include a bid amount provided by an advertiser and an efficient bid amount determined by the bid determination module 240, the bid determination module 240 selects the minimum bid amount for use in an advertisement auction that selects an advertisement for presentation to the viewing user. The functionality of the bid determination module 240 is further described below in conjunction with FIGS. 3 and 4.

The content selection module 245 selects one or more content items for presentation to the viewing user. The content selection module 245 may rank the content item among one or more additional content items based on the efficient bid amount determined for the content item and bid amounts associated with the additional content items and select content items associated with at least a threshold rank or bid amount for presentation to the viewing user. For example, the efficient bid amount for an advertisement is included in an advertisement auction in which the content selection module 245 ranks the advertisement among additional advertisements and selects the advertisement associated with the highest bid amount for presentation to the viewing user. In embodiments in which the content item is a non-advertisement content item, the content selection module 245 may rank the content item among additional content items based on a score or any other suitable value associated with each content item. The functionality of the content selection module 245 is further described below in conjunction with FIG. 3.

The web server 250 links the online system 140 via the network 120 to the one or more client devices 110, as well as to the third party system 130 and/or one or more third party systems. The web server 250 serves web pages, as well as other content, such as JAVA®, FLASH®, XML and so forth. The web server 250 may receive and route messages between the online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID™, WEBOS® or BlackberryOS.

### Determining an Efficient Bid Amount for an Impression Opportunity

FIG. 3 is a flow chart of a method for determining an efficient bid amount for an impression opportunity for a content item presented to a viewing user of an online system according to one embodiment. In other embodiments, the method may include different and/or additional steps than those shown in FIG. 3. Additionally, steps of the method may be performed in a different order than the order described in conjunction with FIG. 3.

The online system 140 receives 305 values associated with different numbers of potential impressions of a content item (e.g., an advertisement) being presented to a viewing user of the online system 140. The values may be determined by and/or received 305 from a user associated with the content item. For example, if the content item is an advertisement, the values are received 305 from an advertiser and correspond to bid amounts the advertiser is willing to pay in exchange for each impression that potentially may be obtained for the viewing user.

In various embodiments, the information may describe other types of values as well. In some embodiments, the values are associated with potential impressions of multiple content items, such as advertisements for an advertising campaign or content items that are related in some manner. For example, the values are associated with advertisements for a new line of tablet devices, where each advertisement features the tablet in a different color, with a different memory capacity, and/or with a different screen size. As an additional example, values are specific to a set of content items including similar types of content (e.g., videos or pictures). The values also may be associated with different positions within a content display unit or different locations in a display area in which the content item may be presented. For example, a value is associated with an impression of an advertisement that potentially may be obtained for the viewing user, where the advertisement is presented in a particular position within a feed (e.g., a top position in a newsfeed) or an equivalent position in a different location of a display area (e.g., in a banner). Furthermore, in some embodiments, the values are associated with potential impressions of a non-advertisement content item being presented to the viewing user. For example, the values are associated with potential impressions of a content item describing a check-in to a location by a user of the online system 140 connected to the viewing user. The values also may be associated with potential interactions with the content item by the viewing user. For example, the values may be associated with a number of times the viewing user may share or express a preference for the content item. As an additional example, the values may be associated with a price an advertiser is willing to pay each time the viewing user clicks on the content item or completes a purchase associated with the content item after clicking through the content item.

The advertiser value module 230 determines 310 an advertiser value curve specific to the content item based on the values received 305 by the online system 140. For example, points along the advertiser value curve determined 310 for an advertisement represent values provided by an advertiser that correspond to different numbers of potential impressions of the content item that may be obtained for the viewing user (e.g., bid amounts the advertiser is willing to pay for each impression).

FIG. 4 depicts a conceptual diagram of a method for determining an efficient bid amount for an impression opportunity for a content item presented to a viewing user of an online system. In some embodiments, the advertiser value curve 405 is a decreasing curve, where the value 410 of each impression 415 of the content item decreases as the number of the potential impressions 415 of the content item increases. If the values 410 of the potential impressions 415 are plotted as a function of the number of potential impressions 415 that may be obtained for the content item, since advertisers are usually willing to pay more for the first impression 415 of an advertisement for a viewing user and less for each subsequent impression 415 of the advertisement, the values 410 will also decrease as the number of impressions 415 increase, resulting in a decreasing advertiser value curve 405.

The value 410 corresponding to each number of potential impressions 415 of the content item decreases for each additional potential impression 415 because users of the online system 140 are more likely to be interested in viewing content items that they have never viewed than they are in viewing content items that they previously have viewed. Hence, the likelihood of those users performing actions associated with content items (e.g., purchasing services, subscribing to a newsletter, etc.) decreases with each subsequent presentation of the content items. For example, if points along the advertiser value curve 405 describe values 410 that are based on the viewing user's predicted levels of interest in the content item or predicted likelihood of interaction with the content item with each additional impression 415 of the content item, the values 410 will decrease as the number of potential impressions 415 increase.

As noted above, since the values received 305 by the online system 140 may describe values 410 other than bid amounts associated with different numbers of potential impressions 415 of the content item being presented to the viewing user, the advertiser value curve 405 may be determined 310 based on this information as well. In some embodiments, the advertiser value curve 405 is specific to multiple content items (e.g., advertisements for an advertising campaign or content items that are related in some manner). For example, the advertiser value curve 405 is determined 310 for advertisements for a charity event, where each advertisement features a different celebrity that supports the event. As an additional example, the advertiser value curve 405 is specific to a set of content items including similar types of content, such as content items that include videos and are tagged with common keywords. Additionally, the advertiser value curve 405 may describe values associated with potential interactions with the content item by the viewing user. For example, each value of the advertiser value curve 405 corresponds to a number of times the viewing user may click on the content item.

The advertiser value curve 405 also may be determined 310 for the content item based on different values 410 associated with different positions within a content display unit or different locations in a display area in which the content item may be presented. In some embodiments, a different advertiser value curve 405 is determined 310 for each of the positions. For example, each point in the advertiser value curve 405 may represent the value 410 of each impression 415 of a content item that potentially may be obtained for the viewing user, where the advertisement is presented in a particular position within a feed (e.g., a first position in a feed of content items) or an equivalent position in a different location of a display area (e.g., in a pop-up window).

In some embodiments, the advertiser value curve 405 is determined 310 for a non-advertisement content item. For example, the advertiser value module 230 determines 310 the advertiser value curve 405 for a content item describing a photo posted by a user of the online system 140 connected to the viewing user by plotting points associated with a number of impressions 415 of the content item and scores or other types of values 410 determined for the content item that describe the viewing user's predicted level of interest in the content item. In this example, since the user's predicted level of interest in the content item is likely to decrease as the number of impressions 415 of the content item increase, the scores decrease for each additional potential impression 415 of the content item.

The advertiser value curve 405 may be determined 310 for one or more viewing users of the online system 140. In one embodiment, the advertiser value curve 405 is a generic curve that is determined 310 for all viewing users of the online system 140. For example, the advertiser value curve 405 is determined 310 based on an average bid amount that potentially may be obtained for each impression 415 of the content item by all viewing users as the number of impressions 415 increase. Alternatively, the advertiser value curve 405 may be specific to the viewing user. For example, if the viewing user previously has expressed a preference for and shared several content items tagged with the keyword “Fiji,” the value 410 associated with each impression 415 in the advertiser value curve 405 for an advertisement for vacation packages for Fiji is higher for the viewing user than for other users that previously have not performed similar actions associated with content items related to Fiji. The advertiser value curve 405 also may be specific to a group of viewing users based on attributes associated with the users and a predicted likelihood of relevance of the content item to viewing users having the associated attributes. For example, an advertiser value curve 405 for a content item associated with a local farmer's market may be specific to online system users who are associated with a geographic location that is within a threshold distance of the location of the farmer's market.

Referring back to FIG. 3, the online system 140 retrieves 315 stored costs associated with different numbers of impressions 415 achieved for one or more content items previously presented to the viewing user. In one embodiment, the costs are bid amounts paid by one or more advertisers associated with the one or more content items. For example, the online system 140 retrieves 315 information describing winning bid amounts associated with historical impressions 415 achieved for the same content items previously presented to the viewing user. In another embodiment, the stored information may be associated with previous interactions by the viewing user with the content item(s). For example, the values may be associated with a number of times the viewing user shared, commented on, or expressed a preference for the content items. As an additional example, the values may be associated with a price an advertiser paid each time the viewing user clicked on the content items or subscribed to a service associated with the content items after clicking through the content items.

In some embodiments, the stored values are received from multiple content publishers. For example, the online system 140 tracks impressions 415 obtained for viewing users of multiple content publishers using a tracking mechanism (e.g., cookies) and stores the information describing impressions 415 obtained across all of the content publishers for each viewing user. In this example, the online system 140 may subsequently retrieve 315 this stored information.

The user cost module 235 determines 320 a user cost curve that is specific to the viewing user. The user cost curve is determined 320 based on the stored costs retrieved 315 by the online system 140. Each point along the user cost curve may represent a cost of a historical impression 415 of a content item that was achieved for the viewing user. For example, if the user cost curve is determined 320 based on a cost associated with each previous impression 415 of an advertisement obtained for the viewing user, the cost of each impression 415 corresponds to a minimum bid amount required to win an auction held for the impression opportunity.

Referring again to FIG. 4, in some embodiments, the user cost curve 420 is an increasing curve, where the costs 410 associated with each impression 415 of the content items increase as the number of the impressions 415 achieved for the content items increases. If the costs 410 associated with the achieved impressions 415 are plotted as a function of the number of achieved impressions 415 that were obtained for the content items, since advertisers usually pay less for the first impression 415 of an advertisement for a viewing user and more for each subsequent impression 415 of the advertisement, the costs 410 will also increase as the number of impressions 415 increase, resulting in an increasing user cost curve 420. The cost 410 corresponding to each number of achieved impressions 415 of the content items increases for each additional potential impression 415 since viewing users of the online system 140 are generally more interested in viewing content items they have never viewed than they are in viewing content items that they previously have viewed; hence, the online system 140 usually accommodates this in order to maximize user engagement with the online system 140.

The online system 140 may favor presentation of content items users have never viewed over presentation of content items that users previously have viewed by requiring content items to be associated with higher costs 410 in exchange for their presentation if they previously were presented to the viewing user than if they previously were not presented to the viewing user. For example, the online system 140 may determine a score associated with each of several advertisements eligible to be presented to the viewing user, in which the score takes into account a bid amount associated with an advertisement and a number of impressions of the advertisement achieved for the viewing user; the advertisement associated with the highest score is then selected for presentation to the viewing user. In this example, since the selection of newer advertisements is favored over the selection of previously presented advertisements for presentation to the viewing user, the number of impressions may be weighted by a negative factor and the bid amount may be weighted by a positive factor when computing the score, such that advertisements must be associated with increasingly higher bid amounts to achieve each additional impression. As an additional example, the online system 140 may multiply a bid amount associated with an advertisement by a factor that is inversely proportional to the number of previous impressions 415 achieved by the advertisement.

In some embodiments, the user cost module 235 takes into account different positions within a content display unit or different locations in a display area of a client device 110 associated with the viewing user in which the content items were presented when the impressions 415 were obtained for the viewing user. To account for this, a different user cost curve 420 may be determined 320 for each position equivalent in which the impressions 415 were achieved for the same content item. For example, each point in a user cost curve 420 represents an average bid amount paid by advertisers for impressions 415 that were achieved for the viewing user for content items presented in a first position in a horizontally scrollable advertisement unit or an equivalent position in a different display area of a client device 110 associated with the viewing user (e.g., in a first position in a vertically scrollable newsfeed, in a banner, in a pop-up window, etc.).

In some embodiments, the cost associated with each impression 415 in the user cost curve 420 is based on multiple costs associated with impressions 415 obtained for the viewing user for multiple content items. For example, the user cost module 235 determines 320 the user cost curve 420 based on a bid amount associated with each number of impressions 415 (e.g., first, second, etc.) of multiple content items, where the bid amount is a winning bid amount for at least a threshold percentage of the number of impressions 415. As an additional example, the online system 140 determines an average cost to advertisers of the first impressions 415 of multiple content items and an average cost of each additional impression 415 thereafter. In this example, the user cost module 235 determines 320 the user cost curve 420 based on the average costs, such that each point along the user cost curve 420 is associated with a number of impressions 415 of content items previously achieved for the viewing user and a corresponding average winning bid amount for the impressions 415.

The user cost curve 420 may be determined 320 for non-advertisement content items. For example, the user cost module 235 determines 320 a user cost curve 420 for content items describing content posted by users of the online system 140 connected to the viewing user. If the user cost curve 420 is determined 320 for non-advertisement content items, the user cost curve 420 for the content items may describe scores or any other suitable values 410 associated with previous impressions 415 of the content items. For example, the online system 140 determines scores associated with previous impressions 415 of each of multiple content items based on the viewing user's predicted affinity for the content items; the user cost curve 420 is then determined 320 based on the scores, where the scores increase as the number of previous impressions 415 increase.

The user cost module 235 may update the user cost curve 420; this may be done periodically or based on the viewing user's interactions with the online system 140. For example, if the online system 140 predicts that there are 650 advertisement impression opportunities per week for a viewing user that normally logs into the online system 140 three times per day, but halfway through the week, the viewing user has only logged into the online system 140 an average of once per day, the user cost module 235 may adjust the user cost curve 420 to compensate for the decreased number of advertisement impression opportunities for the user, such that the bid amounts associated with the points along the user cost curve 420 are increased. As an additional example, if the viewing user's interactions with the online system 140 increases above a threshold frequency of interactions, the user cost module 235 may adjust the user cost curve 420 by decreasing bid amounts associated with impressions 415 in the user cost curve 420 (e.g., by shifting the user cost curve 420 to the left).

Referring once more to FIG. 3, the bid determination module 240 determines 325 an efficient bid amount for each impression opportunity for a number of total impressions 415 of the content item being presented to the viewing user. The efficient bid amount is determined 325 based on a value 410 corresponding to an intersection 425 of the advertiser value curve 405 and the user cost curve 420, as shown in FIG. 4. For example, if the intersection 425 of the advertiser value curve 405 and the user cost curve 420 correspond to a bid amount of $4.50 and three impressions 415, the efficient bid amount is $4.50 for each impression opportunity for the content item for a total of three impressions 415.

In some embodiments, the efficient bid amount for each impression opportunity may be approximated based on the intersection 425 of the curves. For example, if the curves intersect 425 at a point corresponding to a total of three impressions 415, the bid determination module 240 determines 325 the efficient bid amount for each impression opportunity for a total of three impressions 415 to be a bid amount corresponding to a point along the user cost curve 420 that is less than, but within a threshold of, the bid amount corresponding to the intersection 425 of the curves. If the efficient bid amount for each impression opportunity is approximated based on the intersection 425 of the user cost curve 420 and the advertiser value curve 405 and the efficient bid amount fails to achieve at least a threshold number of impressions 415 after a specified amount of time has elapsed or after a specified number of impression opportunities have come to pass, the bid determination module 240 may gradually increase the efficient bid amount for each impression opportunity until an impression 415 is achieved or the bid amount associated with the intersection 425 of the curves is reached.

In embodiments in which the values 410 for the advertiser value curve 405 and the costs 410 for the user cost curve 420 are expressed as scores or other types of values/costs 410, an efficient score or other type of value may be similarly determined based on the intersection 425 of the curves. For example, if the values 410 for the advertiser value curve 405 and the costs 410 for the user cost curve 420 are associated with interactions by the viewing user, the efficient bid amount is determined for each interaction opportunity for the viewing user based on a bid amount and a number of interactions associated with the intersection 425 of the advertiser value curve 405 and the user cost curve 420. In embodiments in which the impression opportunity is for a non-advertisement content item, an efficient value or score may be determined 325 for the content item that corresponds to an intersection 425 of the two curves. For example, a score corresponding to the intersection 425 of the advertiser value curve 405 and user cost curve 420 that indicates the viewing user's expected affinity for the content item is determined 325 to be the efficient score for the content item. The bid determination module 240 may convert scores or values 410 to bid amounts or vice versa so that the types of values 410 for the advertiser value curve 405 and the types of costs 410 for the user cost curve 420 match and an efficient bid amount, score, or other suitable value 410 may be determined 325 by the bid determination module 240. For example, the bid determination module 240 may multiply scores associated with potential impressions 415 that may be obtained for a content item along an advertiser value curve 405 by a conversion factor that converts the scores into bid amounts.

In some embodiments, if multiple bid amounts are associated with the content item, the bid determination module 240 may select 330 a minimum bid amount from the multiple bid amounts for use in a content selection process used to select content items for presentation to the viewing user. For example, if bid amounts associated with an advertisement include a bid amount provided by an advertiser and an efficient bid amount determined by the bid determination module 240, the bid determination module 240 selects 330 the minimum bid amount for use in an advertisement auction that selects an advertisement for presentation to the viewing user. In some embodiments, the bid determination module 240 may select 330 the efficient bid amount for inclusion in the content selection process if the number of total impressions 415 associated with the efficient bid amount for the content item is less than a threshold number of impressions. The bid determination module 240 may determine the threshold number of total impressions based on various types of information. For example, the bid determination module 240 determines a threshold number of impressions of the content item based on a frequency cap associated with presenting the content item; if the total number of impressions 415 corresponding to the efficient bid amount is less than the threshold number of impressions, the efficient bid amount is used in a content selection process (e.g., an auction system). As an additional example, if the goal of presenting a content item is for the viewing user to perform an action associated with the content item and a machine-learned model used in a content selection process will only decrease the frequency with which it presents the content item to the viewing user if the user fails to perform the action after a specified number of impressions, the bid determination module 240 determines that the threshold number of total impressions of the content item is equivalent to this specified number of impressions.

The content selection module 245 selects 335 one or more content items for presentation to the viewing user upon identifying an opportunity to present content to the viewing user. The content selection module 245 may rank the content item among one or more additional content items based on the efficient bid amount determined 325 for the content item and bid amounts associated with the additional content items and select 335 content items associated with at least a threshold rank or bid amount for presentation to the viewing user. For example, the efficient bid amount for an advertisement is included in an advertisement auction that ranks the advertisement among additional advertisements, where the advertisement associated with the highest bid amount is selected 335 for presentation to the viewing user. In embodiments in which the content item is a non-advertisement content item, the content selection module 245 may rank the content item among additional content items based on the score or any other suitable value 410 associated with each content item.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, a plurality of values associated with potential impressions of a content item being presented to a viewing user of the online system, each of the plurality of values comprising a value that an advertiser is willing to pay for a number of the potential impressions of the content item;
determining an advertiser value curve for the content item based at least in part on the plurality of values, the advertiser value curve comprising a decreasing function of the advertiser value curve for a value of a potential impression of the content item to the advertiser as the number of the potential impressions of the content item increases;
retrieving a plurality of stored values associated with one or more content items previously presented to the viewing user, each of the plurality of stored values comprising a cost incurred by one or more advertisers for a number of impressions of the one or more content items previously presented to the viewing user;
determining a user cost curve for the content item associated with the viewing user based at least in part on the plurality of stored values, the user cost curve comprising an increasing function of the user cost curve for a cost of an impression of the one or more content items incurred by the one or more advertisers as the number of the impressions of the one or more content items previously presented to the viewing user increases; and
determining an efficient bid amount for a number of impressions of the content item being presented to the viewing user based at least in part on an intersection of the advertiser value curve and the user cost curve.

2. The method of claim 1, further comprising:
identifying an opportunity to present the content item to the viewing user;
determining a minimum bid amount associated with the content item from a set of bid amounts associated with the content item, the set of bid amounts comprising the efficient bid amount;
including the minimum bid amount associated with the content item in a content selection process; and
selecting one or more content items for presentation to the viewing user based at least in part on the minimum bid amount associated with the content item.

3. The method of claim 1, wherein the efficient bid amount comprises a value corresponding to the intersection of the advertiser value curve and the user cost curve.

4. The method of claim 1, wherein the efficient bid amount comprises a bid amount corresponding to a point along the user cost curve that is within a threshold of an additional bid amount corresponding to the intersection of the advertiser value curve and the user cost curve.

5. The method of claim 1, wherein the number of impressions of the content item comprises a number of impressions corresponding to the intersection of the advertiser value curve and the user cost curve.

6. The method of claim 1, wherein each of the plurality of values is associated with a set of equivalent positions in a display area in which the content item potentially may be presented to the viewing user and each of the plurality of stored values is associated with the set of equivalent positions in the display area in which the one or more content items were previously presented to the viewing user.

7. The method of claim 6, wherein the efficient bid amount is for a number of impressions of the content item presented to the viewing user in one or more positions of the set of equivalent positions.

8. The method of claim 1, wherein the plurality of stored values is retrieved from a plurality of content publishers.

9. The method of claim 1, wherein determining the user cost curve for the content item associated with the viewing user based at least in part on the plurality of stored values comprises:
for each of the number of impressions of the one or more content items previously presented to the viewing user:
identifying a set of values from the plurality of stored values associated with the number of impressions of the one or more content items previously presented to the viewing user, and
determining a value associated with the number of impressions of the one or more content items previously presented to the viewing user, the value associated with at least a threshold percentage of the set of values; and
determining the user cost curve based at least in part on the determined values for each of the number of impressions of the one or more content items previously presented to the viewing user.

10. The method of claim 1, wherein the advertiser value curve is further based at least in part on a plurality of values associated with potential impressions of the content item presented to one or more additional viewing users of the online system.

11. The method of claim 10, wherein the one or more additional viewing users of the online system are associated with at least a threshold number of attributes associated with the viewing user.

12. The method of claim 1, wherein the user cost curve is adjusted based at least in part on a set of interactions by the viewing user with the online system.

13. A computer program product comprising a computer readable storage medium having instructions encoded thereon that, when executed by a processor, cause the processor to:
receive, at an online system, a plurality of values associated with potential impressions of a content item being presented to a viewing user of the online system, each of the plurality of values comprising a value that an advertiser is willing to pay for a number of the potential impressions of the content item;
determine an advertiser value curve for the content item based at least in part on the plurality of values, the advertiser value curve comprising a decreasing function of the advertiser value curve for a value of a potential impression of the content item to the advertiser as the number of the potential impressions of the content item increases;
retrieve a plurality of stored values associated with one or more content items previously presented to the viewing user, each of the plurality of stored values comprising a cost incurred by one or more advertisers for a number of impressions of the one or more content items previously presented to the viewing user;
determine a user cost curve for the content item associated with the viewing user based at least in part on the plurality of stored values, the user cost curve comprising an increasing function of the user cost curve for a cost of an impression of the one or more content items incurred by the one or more advertisers as the number of the impressions of the one or more content items previously presented to the viewing user increases; and
determine an efficient bid amount for a number of impressions of the content item being presented to the viewing user based at least in part on an intersection of the advertiser value curve and the user cost curve.

14. The computer program product of claim 13, wherein the computer readable storage medium further has instructions encoded thereon that, when executed by the processor, cause the processor to:
identify an opportunity to present the content item to the viewing user;
determine a minimum bid amount associated with the content item from a set of bid amounts associated with the content item, the set of bid amounts comprising the efficient bid amount;
include the minimum bid amount associated with the content item in a content selection process; and
select one or more content items for presentation to the viewing user based at least in part on the minimum bid amount associated with the content item.

15. The computer program product of claim 13, wherein the efficient bid amount comprises a value corresponding to the intersection of the advertiser value curve and the user cost curve.

16. The computer program product of claim 13, wherein the efficient bid amount comprises a bid amount corresponding to a point along the user cost curve that is within a threshold of an additional bid amount corresponding to the intersection of the advertiser value curve and the user cost curve.

17. The computer program product of claim 13, wherein the number of impressions of the content item comprises a number of impressions corresponding to the intersection of the advertiser value curve and the user cost curve.

18. The computer program product of claim 13, wherein each of the plurality of values is associated with a set of equivalent positions in a display area in which the content item potentially may be presented to the viewing user and each of the plurality of stored values is associated with the set of equivalent positions in the display area in which the one or more content items were previously presented to the viewing user.

19. The computer program product of claim 18, wherein the efficient bid amount is for a number of impressions of the content item presented to the viewing user in one or more positions of the set of equivalent positions.

20. The computer program product of claim 13, wherein the plurality of stored values is retrieved from a plurality of content publishers.

21. The computer program product of claim 13, wherein determine the user cost curve associated with the viewing user based at least in part on the plurality of stored values comprises:
for each of the number of impressions of the one or more content items previously presented to the viewing user:
identify a set of values from the plurality of stored values associated with the number of impressions of the one or more content items previously presented to the viewing user, and
determine a value associated with the number of impressions of the one or more content items previously presented to the viewing user, the value associated with at least a threshold percentage of the set of values; and
determine the user cost curve based at least in part on the determined values for each of the number of impressions of the one or more content items previously presented to the viewing user.

22. The computer program product of claim 13, wherein the advertiser value curve is further based at least in part on a plurality of values associated with potential impressions of the content item presented to one or more additional viewing users of the online system.

23. The computer program product of claim 22, wherein the one or more additional viewing users of the online system are associated with at least a threshold number of attributes associated with the viewing user.

24. The computer program product of claim 13, wherein the user cost curve is adjusted based at least in part on a set of interactions by the viewing user with the online system.

25. A method comprising:
determining, at an online system, a plurality of values associated with potential impressions of a content item being presented to a viewing user of the online system, each of the plurality of values based at least in part on a predicted affinity of the viewing user for the content item for each of a number of the potential impressions of the content item;
determining a content value curve for the content item based at least in part on the plurality of values, the content value curve comprising a decreasing function of the content value curve for a value of a potential impression of the content item as the number of the potential impressions of the content item increases;
retrieving a plurality of stored values associated with one or more content items previously presented to the viewing user, each of the plurality of stored values based at least in part on predicted affinities of the viewing user for the one or more content items for a number of impressions of the one or more content items;
determining a user value curve for the content item associated with the viewing user based at least in part on the plurality of stored values, the user value curve comprising an increasing function of the user value curve for a value of an impression of the one or more content items as the number of the impressions of the one or more content items previously presented to the viewing user increases; and
determining an efficient value for a number of impressions of the content item being presented to the viewing user based at least in part on an intersection of the content value curve and the user value curve.
